(19) United States
(12) Patent Application Publication
(10) Pub. No.: US 2009/0198355 A1
(43) Pub. Date: Aug. 6, 2009

(54) Ear-mounted MP3 player with radio and remote control

(76) Inventor: Donzell D. Powell, Suffolk, VA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/068,357

(22) Filed: Feb. 5, 2008

(51) Int. Cl. G06F 17/00; G06F 13/00

(52) U.S. Cl. 700/94; 710/300

(57) ABSTRACT

The ear-mounted MP-3 player with radio and remote control is a battery-operated MP3 player that can be mounted on a user's ear. The ear-mounted MP3 player includes a wireless feature, a talking stopwatch/clock with display, an am-fm radio, a built-in antenna, and a device locator. A separate key fob-sized wireless remote control having a light located at its tip is provided to activate features of the MP3 player, including the device locator. The MP3 player includes flash drive media storage. In addition to function buttons on the player, a stopwatch, a volume control, a device locator, a radio station tuner, and MP3 download are accessible via the remote control.

### CROSS-REFERENCE TO RELATED APPLICATION

This application claims the benefit of U.S. Provisional Patent Application Ser. No. 60/899,403, filed Feb. 5, 2007.

### BACKGROUND OF THE INVENTION

1. Field of the Invention

The present invention relates to audio headsets, and more particularly to an ear-mounted MP3 player with radio and remote control that provides an audio headset having a built-in media player, a handheld remote control, and a device locator.

2. Description of the Related Art

Due to the recent widespread popularity of handheld consumer electronic devices, such as mobile handsets and MP3 players, audio headsets of a variety of designs have been introduced into the marketplace. However, most headsets continue to be “passive” devices that deliver audio signals from an external audio source to the ear(s) of a user via a wired connection. The headset cannot function to deliver audio content without the external audio source. Traditionally, the headset and the external audio source have been separate devices. It is believed that until the present invention there currently is no headset that combines the convenience of having a built-in media player, a handheld remote control device, and a device locator in a single, user-friendly platform.

Thus, an ear-mounted MP3 player with radio and remote control solving the aforementioned problems is desired.

### SUMMARY OF THE INVENTION

The ear-mounted MP3 player with radio and remote control is a battery operated MP3 player that can be mounted on a user's ear. The ear-mounted MP3 player includes a wireless feature, a talking stopwatch/clock with display, an AM-FM radio, built-in antenna, and a device locator. A separate key fob-sized wireless remote control having a light located at its tip is provided to activate features of the MP3 player, including the device locator. The MP3 player includes flash drive media storage. In addition to function buttons on the player, a stopwatch, a volume control, a device locator, a radio station tuner, and MP3 download are accessible via the remote control. When activated, the device locator sounds a beep in the player and strobes a source of illumination located on or within the player. An ear attachment bracket of the ear-mounted MP3 player is of a loop-style design and adapted for use on a user's left ear or right ear.

These and other features of the present invention will become readily apparent upon further review of the following specification and drawings.

### BRIEF DESCRIPTION OF THE DRAWINGS

FIG. 1 is an environmental, perspective view of an ear-mounted MP3 player with radio and remote control according to the present invention.

FIG. 2A is a front perspective view of the ear-mounted MP3 player according to the present invention.

FIG. 2B is a rear perspective view of the ear-mounted MP3 player according to the present invention.

FIG. 3 is a top perspective view of a remote control for the ear-mounted MP3 player according to the present invention.

FIG. 4 is a block diagram of the ear-mounted MP3 player with radio and remote control according to the present invention.

Similar reference characters denote corresponding features consistently throughout the attached drawings.

### DETAILED DESCRIPTION OF THE PREFERRED EMBODIMENT

The ear-mounted MP3 player with radio and remote control is a battery-operated MP3 player that can be mounted on a user's ear. The ear-mounted MP3 player includes a wireless feature, a talking stopwatch/clock with display, an AM-FM radio, a built-in antenna, and a device locator. A separate key fob-sized wireless remote control having a light located at its tip is provided to activate features of the MP3 player, including the device locator. The MP3 player includes flash drive media storage. In addition to function buttons on the player, a stopwatch, a volume control, a device locator, a radio station tuner, and MP3 download are accessible via the remote control. When activated, the device locator sounds a beep in the player and strobes a source of illumination located on or within the player. An ear attachment bracket of the ear-mounted MP3 player is of a loop-style design and adapted for use on a user's left ear or right ear.

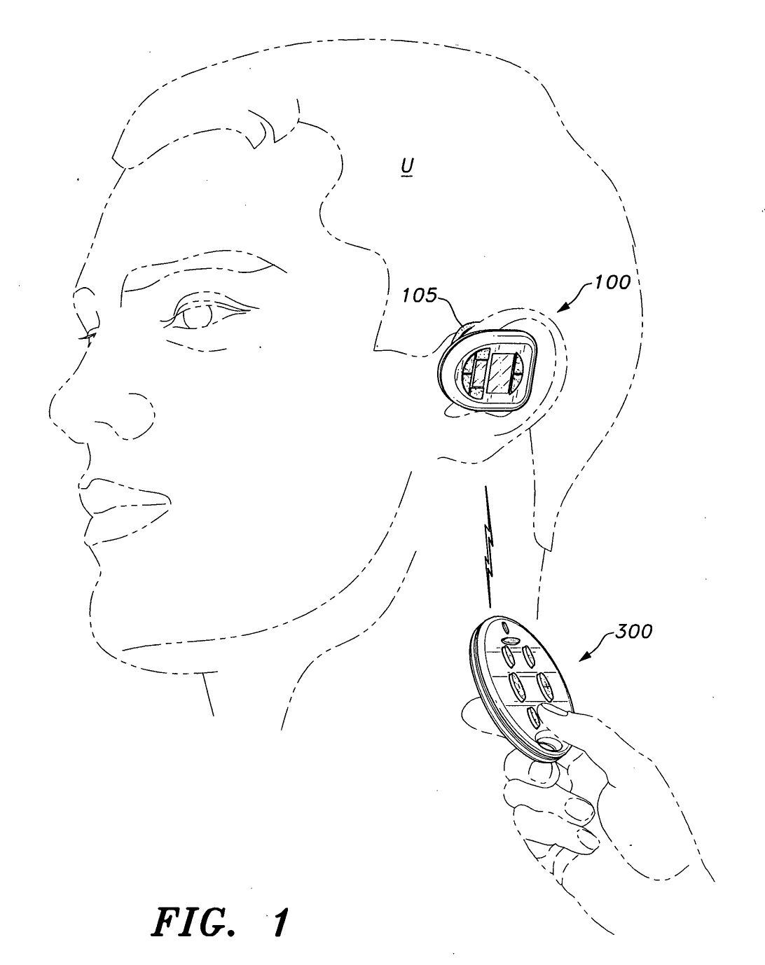

As shown in FIGS. 1, 2A, 2B, and 4, the ear-mounted MP3 player 100 is preferably powered by at least one battery B and is provided with a device locator 435 that can flash a light 440 on or in the device, as well as beep the device 100 so that a lost device 100 is made audibly and visually conspicuous enough to find and retrieve. A housing 500 having front, side, and rear surfaces is adapted for connection to an ear loop 105. The ear loop 105 is attached to the rear surface of the housing 500 in order to provide secure attachment of the device 100 to a user's ear during use. The housing 500 is an enclosure that supports/covers all components of device 100 except for the remote control unit 300, which has its own separate enclosure. A miniature speaker 220 is attached to the rear surface of the housing 500 so that a diaphragm of the speaker 220 is sufficiently exposed to transmit sound as amplified by amplifier 425 to a user U when the device 100 is in proximity to the user's ear. The user U may adjust the volume via function buttons 403 that are read by processor 400 in order to generate a volume control signal to amplifier 425.

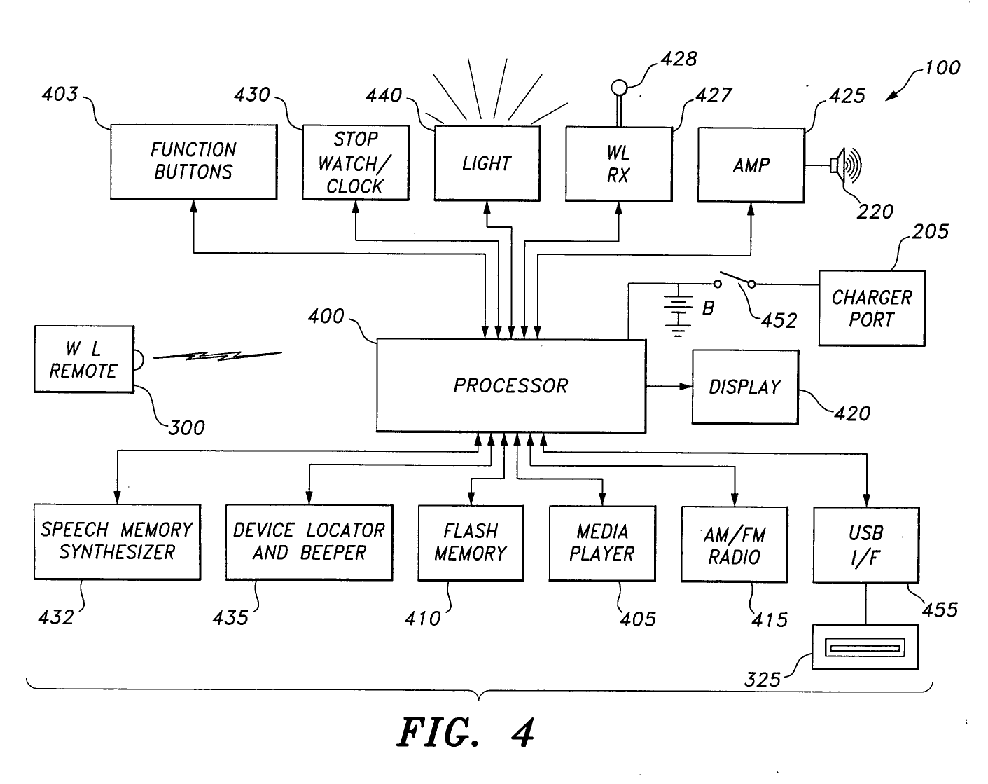

As most clearly shown in FIG. 4, the MP3 player 100 has a charging port 205 and a switch 252 so that when a charging current is applied to the device 100, charging current is directed to the battery B. A digital media player 405 is disposed in the housing 500 and may comprise discrete or integrated components capable of being controlled by processor 400 in order to play desired media content stored in media flash memory 410. Additionally, an AM-FM radio 415 is provided so that on-air content can be played by device 100. Preferably, processor 400 also controls the AM-FM radio 415.

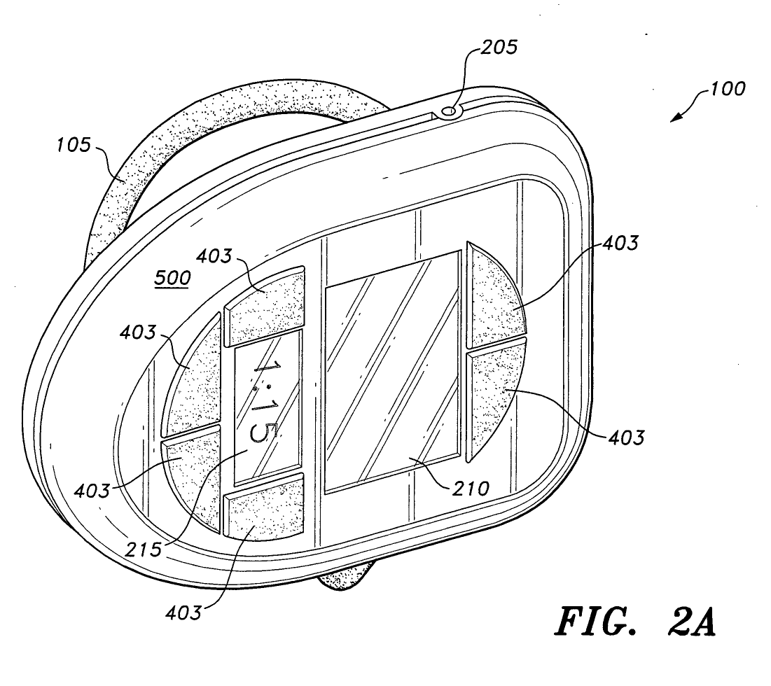

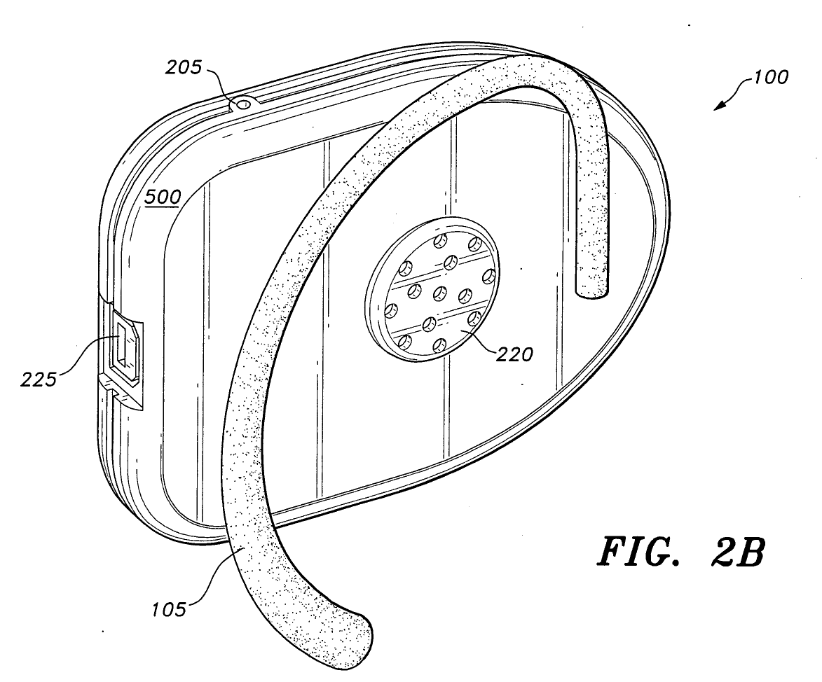

Disposed on at least one of the surfaces of the media player housing 500 is at least one function button 403 for controlling at least one feature of the device 100. A stopwatch/clock module is disposed in the enclosure 500 and is connected to a display 420, the display 420 being disposed on a front surface of the enclosure 500 and being capable of displaying stopwatch time, clock time, status of media player 405, and the like. Display 420 may be configured as one large screen, or, as shown in FIG. 2A, may be broken up into two screens 210 and 215. As shown in FIG. 2B the ear-mounted radio and media player 100 may have a data port 225 to provide the player 100 with the capability of downloading media content for storage to, and retrieval from, flash memory device 410. The data port 225 shown in FIG. 2B and FIG. 4 is a mini-USB port in operable communication with USB interface 455. Optionally, the housing 500 may have a spring-loaded lid (not shown) that can cover the data port 225 when not in use.

A speech memory and/or speech synthesizer 432 is provided for annunciation via speaker 220 of critical functions of the device 100, such as time/date and stopwatch time.

As shown in FIGS. 1 and 4, the ear-mounted radio and media player 100 may have a wireless receiver 427 and an antenna 428 in order to accept control signals from the wireless handheld remote control unit 300. For example, wireless remote 300 can wirelessly send a locator activate control signal that is received by wireless receiver 427 via antenna 428. In response to the control signal, processor 400 can instruct conspicuously located light 440 to flash, and device locator response unit/beeper 435 to activate. It is within contemplation of the present invention that the unit 100 is capable of responding to additional remote control signals, such as media transport control, i.e., “back”, “forward”, “skip”, “shuffle”, “random”, “stop”, and the like. Additionally, clock/stopwatch functions may be set by remote control of the device 100. The aforementioned functions may also be implemented by function buttons 403.

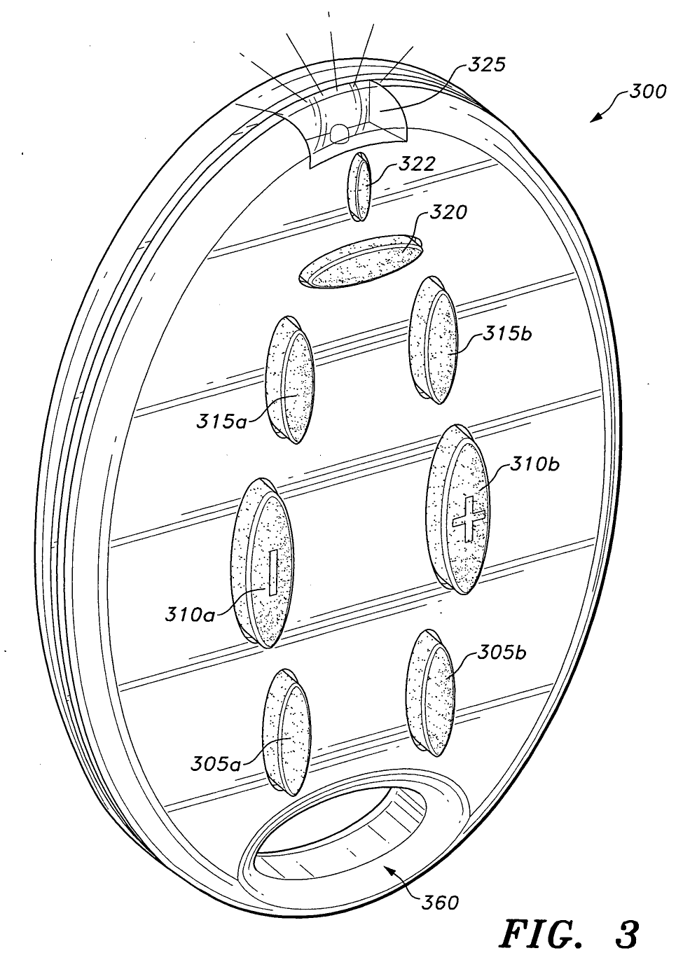

As shown in FIG. 3, the wireless remote control unit 300 has a visually and ergonomically pleasing shape that preferably is of a key fob size. Aperture 360 is suitably adapted to receive a key ring for easy transport in a user's pocket. The wireless remote control unit 300 has a plurality of control buttons, most of which are mapped to corresponding functions on the ear-mounted media player. However, button 322 functions as an on/off switch for penlight lamp 325 located on the remote control unit 300. Button 320 is programmed to send the aforementioned remote locator control signal to the player 100. Buttons 415a and 315b are programmed to send the aforementioned transport control signals. Remote volume control is provided by buttons 310a and 310b. Clock/stopwatch function controls are provided by buttons 305a and 305b.

It is to be understood that the present invention is not limited to the embodiment described above, but encompasses any and all embodiments within the scope of the following claims.

I claim:

1. An ear-mounted media player, comprising:
a housing having external front, side and rear surfaces;
an ear loop connected to the external rear surface of the housing;
a miniature speaker disposed on the external rear surface of the housing;
a portable power source disposed in the housing;
a media player device disposed in the housing, the media player device having electronic circuitry for playing stored audio content, including MP3, through the miniature speaker;
a function button disposed on the housing, the function button controlling the media player device;
a stopwatch/clock module disposed in the housing;
a stopwatch/clock display disposed on the front surface of the housing for displaying output of the stopwatch/clock module;
a voice memory/synthesizer disposed in the housing for annunciating output of the stopwatch/clock via the miniature speaker;
a media player function/status display disposed on the front surface of the media player device housing for displaying status of the player;
a data store disposed in the housing for storing media data;
a data port on the housing for accepting media content for storage by the data store and play by the media player;
a wireless handheld remote control device having at least one function button adapted for controlling at least one function of the media player;
a wireless receiver disposed in the housing for receiving control signals from the wireless handheld remote control device;
a flasher disposed on the housing;
a beeper disposed in the housing;
an AM/FM radio receiver disposed in the housing; and
a remote locator response unit disposed in the housing for activating the flasher and the beeper responsive to a signal from the wireless handheld remote control device.

2. The ear-mounted media player according to claim 1, wherein the media player device further comprises a processor, the processor being connected to the power source, the function button, the stopwatch/clock module, the voice memory/synthesizer, the stopwatch/clock, the media player function/status displays, the data store, the data port, the wireless remote receiver, the flasher, the device locating beeper, and the AM/FM radio.

3. The ear-mounted media player according to claim 2, further comprising an amplifier interconnecting the processor and the miniature speaker.

4. The ear-mounted media player according to claim 1, further comprising a switchable charging port connected to the portable power source.

5. The ear-mounted media player according to claim 1, wherein the data store comprises a flash memory module.

6. The ear-mounted media player according to claim 1, wherein the stopwatch/clock display and the media player function/status display are combined into one large multifunction screen.

7. The ear-mounted media player according to claim 1, wherein the wireless handheld remote control device further comprises a light disposed on the remote control device, the light activating features of the MP3 player, including the device locator.

8. The ear-mounted media player according to claim 1, wherein the data port further comprises:
a mini-USB port; and
a USB interface, the USB interface operably interconnecting the mini-USB port and the processor.

9. The ear-mounted media player according to claim 1, wherein the wireless handheld remote control device includes media transport function buttons, the media transport function buttons controlling “back”, “forward”, “skip”, “shuffle”, “random”, “stop” operations of the media player.
